(19) United States
(12) Patent Application Publication
(10) Pub. No.: US 2004/0266500 A1
(43) Pub. Date: Dec. 30, 2004

(54) Automatic function control of an antenna unit of a vehicle-mounted toll unit of an electronic toll system

(76) Inventors: Janos Gila, Osterreich (AT); Wolfgang Konrad, Osterreich (AT); Alexander Renner, Osterreich (AT)

Correspondence Address: HARNESS, DICKEY & PIERCE, P.L.C., P.O.BOX 8910, RESTON, VA, 20195, US

(21) Appl. No.: 10/493,607

(22) PCT Filed: Oct. 16, 2002
(86) PCT No.: PCT/DE02/03920

(30) Foreign Application Priority Data
Oct. 24, 2001 (AT) 16912001

(51) Int. Cl. H04B 1/06; H04B 7/00; H05K 11/02

(52) U.S. Cl. 455/575.7; 455/272; 455/345

(57) ABSTRACT

An automatic function control of an antenna unit of a vehicle-mounted toll unit of an electronic toll system including a position detection system is disclosed. The toll unit includes a reception unit linked with the antenna unit and the antenna unit is adapted to receive position detection signals. At least one control signal that interacts with the antenna unit is produced and supplied to the toll unit, and the function of the antenna unit is checked by use of the control signal.

This application is the national phase under 35 U.S.C. § 371 of PCT International Application No. PCT/DE02/03920 which has an International filing date of Oct. 16, 2002, which designated the United States of America and which claims priority on Austrian Patent Application number AT 1691/2001 filed Oct. 24, 2001, the entire contents of which are hereby incorporated herein by reference.

### FIELD OF THE INVENTION

The invention generally relates a method for automatic functional monitoring of an antenna unit for a vehicle-mounted toll-payment unit for an electronic toll system.

The invention furthermore generally relates to a toll system for electronic toll payment having a position determination system and a vehicle-mounted toll-payment unit, which has an antenna unit and a receiving unit which is connected to the antenna unit, with the antenna unit being designed to receive position determination signals.

### BACKGROUND OF THE INVENTION

A toll system has been disclosed in DE 43 44 433 A1. In the known method, current position coordinates are detected by a GPS receiver and are compared with the entry/exit coordinates (which are stored in an electronic label) of a turnpike section. If the coordinates match, they are transmitted by way of the digital mobile network to a payment center which is external to the vehicle. The distance which has been traveled on the turnpike as well as the turnpike charges associated with this distance are calculated from the transmitted data in the payment center.

WO 95/20801 discloses a toll system for determination of usage charges for roadways and/or traffic areas, in which the position data for the vehicle is detected by way of a position determination system, and is compared with the positions of virtual toll points. In order to calculate the toll charges, the position data can be transmitted to a control center external to the vehicle, in which case the charges may also be calculated in a toll-payment unit in the vehicle, with the charges determined being transmitted to the control center, where they can then be debited from an account.

WO 99/33027 describes a method for collecting toll charges, in which the current position of the vehicle is compared with the position of the virtual toll point in order to calculate toll charges. A communication connection is set up between the vehicle and a central toll control point when a vehicle drives through a physical toll station, in order to pay the toll charges incurred. Once a payment transaction has taken place between the toll station and the vehicle, a communication connection is set up via which verification of correct payment of the toll charge is transmitted.

In electronic toll systems which have a position determination system—for example a satellite-based position determination system such as GPS, in which position data is transmitted via an antenna unit for a vehicle-mounted toll-payment unit to a receiver in the toll-payment unit—the serviceability of the antenna unit is essential in order to make it possible to carry out a correct toll payment. Since the antenna unit is normally arranged on the outside of the vehicle, the antenna unit may become mechanically damaged. If the antenna is covered with aluminum foil, this can also lead to correct toll payment no longer being possible.

### SUMMARY OF THE INVENTION

One object of an embodiment of the invention is therefore to create a way which allows the serviceability of the antenna unit of a vehicle-mounted toll-payment apparatus to be checked easily and in a cost-effective manner.

An object may be achieved by a method for automatic functional monitoring of an antenna unit for a vehicle-mounted toll-payment unit for an electronic toll system, having a position determination system, with the toll-payment unit having a receiving unit which is connected to the antenna unit, and the antenna unit being designed to receive position determination signals. At least one monitoring signal, which interacts with the antenna unit, is produced, is fed to the toll-payment unit, and the operation of the antenna unit is checked on the basis of the monitoring signal.

For the purposes of this document, the expression signal includes both an analog and a digital electrical signal, such as a binary-coded signal or an analog DC/AC voltage, etc. The monitoring signal can on the one hand be used to check whether a signal transmission connection from the antenna unit to the receiver unit is interrupted and, on the other hand, can also be used to determine electrical characteristics of the signal transmission connection between the antenna unit and the receiver unit. The electrical characteristics of the signal transmission connection of the antenna unit and receiver unit in this case represents a further measure for the serviceability of the antenna unit.

The monitoring signal may be produced as a pilot signal, may be fed to the antenna unit, and the presence of the monitoring signal may be detected at the receiver. In this case, a pilot signal refers to a low-power reference signal which is transmitted in addition to the useful signal. By feeding a pilot signal to the antenna unit, it is possible to detect an interruption in the signal transmission connection between the antenna unit and the receiver unit in a simple and cost-effective manner. In one advantageous variant of an embodiment of the invention, the monitoring signal may be transmitted together with the position determination signal.

The monitoring signal is preferably produced at time intervals which can be predetermined.

In one advantageous variant of an embodiment of the invention, the monitoring signal is produced on board the vehicle.

According to the variant of an embodiment of the invention mentioned above, the monitoring signal may be produced by a vehicle-mounted functional monitoring unit which is connected to the toll-payment unit, and may be fed to a signal transmission connection between the antenna unit and the receiving unit. Electrical characteristics and/or reflection characteristics of the signal transmission connection are determined by the functional monitoring unit from a reflected component of the monitoring signal.

The monitoring signal can thus be used to determine values for electrical characteristics and/or reflection characteristics of the signal transmission connection, and to compare these characteristics with nominal values for these characteristics.

Further advantages can be achieved by determining the impedance and/or the operating loss of the signal transmission connection between the antenna unit and the receiving unit.

According to one advantageous embodiment of the invention, the reflection characteristics of the signal transmission connection between the antenna unit and the receiving unit, and/or the electrical characteristics of the signal transmission connection, are determined by way of time domain reflectometry.

If a malfunction of the antenna unit is identified, an appropriate information signal can be produced and can be displayed on the vehicle. Thus, it is possible to use the information signal to identify a malfunction of the antenna when passing a monitoring point on the road, and to initiate appropriate measures in order to overcome this defect.

A toll payment system which is particularly suitable for carrying out the method according to an embodiment of the invention is designed to produce at least one monitoring signal, which interacts with the antenna unit, for automatic functional checking of the antenna unit, to feed this to the toll-payment unit, and to check the operation of the antenna unit using the monitoring signal.

In one advantageous embodiment of the invention, the toll system may be designed to produce the monitoring signal as a pilot signal, to feed the monitoring signal to the antenna unit, and to detect the presence of the monitoring signal at the receiver. Furthermore, the toll system can advantageously be designed to transmit the monitoring signal together with the position determination signal.

Furthermore, the toll system may be designed to produce the monitoring signal at time intervals which can be predetermined.

A signal generator for producing the monitoring signal may advantageously be provided on board the vehicle.

Further advantages can be achieved by providing a functional monitoring unit, which is connected to the toll-payment unit, on board the vehicle, and which may be designed to produce the monitoring signal and to feed it to a signal transmission connection between the antenna unit and the receiving unit, with the functional monitoring unit determining electrical characteristics and/or reflection characteristics of the signal transmission connection from a reflected component of the monitoring signal.

Furthermore, the functional monitoring unit may be designed to determine the impedance and/or the operating loss of the signal transmission connection between the antenna unit and the receiving unit.

The functional monitoring unit may be designed to determine reflection characteristics and/or electrical characteristics of the signal transmission connection between the antenna unit and the receiving unit by way of time domain reflectometry.

In one preferred variant of an embodiment of the invention, the toll system may be designed, when a malfunction in the antenna unit is identified, to produce an appropriate information signal, and to display this on the vehicle.

### BRIEF DESCRIPTION OF THE DRAWINGS

The invention together with further advantages will be explained in more detail in the following text with reference to a number of non-restrictive exemplary embodiments which are illustrated in the drawings, in which, schematically:

FIG. 1 shows a toll system according to an embodiment of the invention;

FIG. 2 shows a toll-payment apparatus with an antenna unit and a functional monitoring unit according to a first variant of an embodiment of the invention; and

FIG. 3 shows a toll-payment apparatus with an antenna unit and a functional monitoring unit according to a second variant of an embodiment of the invention.

### DETAILED DESCRIPTION OF THE PREFERRED EMBODIMENTS

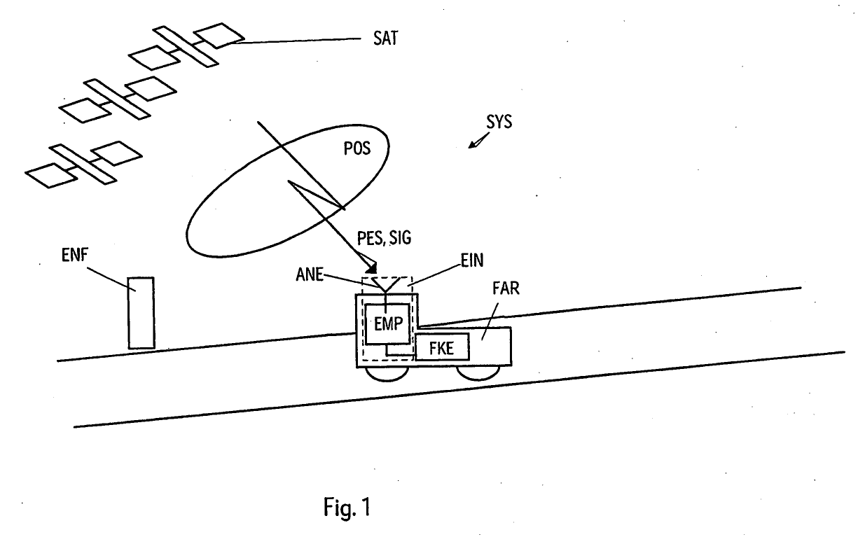

As is shown in FIG. 1, a toll system SYS according to an embodiment of the invention has a position determination system POS, for example a satellite-based position determination system such as GPS, or some other position determination system based on radio transmission, for example based on a GSM network.

In order to determine the position of a vehicle FAR and to make a toll payment on the basis of its position coordinates, the vehicle has a toll-payment unit EIN which has an antenna unit ANE which is designed to be able to receive position determination signals PES from the position determination system POS. In order to simplify the illustration, only those elements which are significant to an embodiment of the invention are shown in the toll-payment unit EIN, specifically the antenna unit ANE and the receiving unit EMP. It is self-evident that further elements, such as a controller for calculation of position coordinates of the vehicle FAR from the received position determination data PED, etc, will also be provided in the toll-payment unit EIN. Moreover, for the purposes of this document, the expression “toll-payment unit” includes a functional unit, which may be physically distributed around the vehicle FAR.

The antenna unit ANE is connected to a receiving unit EMP for the toll-payment unit EIN via a signal transmission connection VER, for example an antenna cable. In the situation where the position determination system POS is the GPS system, the toll-payment unit EIN may have a GPS module with an appropriate receiving unit.

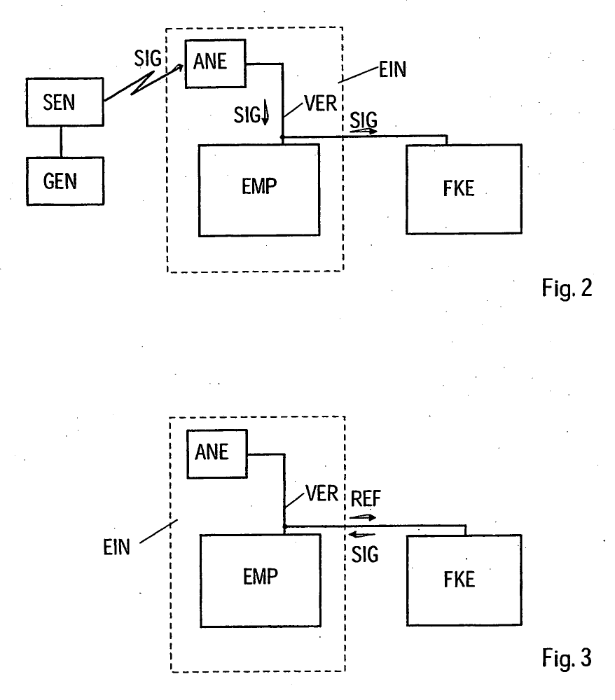

As is shown in FIG. 2, in order to check the operation of the antenna unit ANE and/or of the signal transmission connection VER between the antenna unit ANE and the receiving unit EMP, a monitoring signal SIG may be transmitted from the position determination system POS as pilot signal, for example in the form of a direct current or alternating current, to the toll-payment unit EIN, and may be fed to the antenna unit ANE. If the position determination system POS is the GPS system, then the pilot signal may also be transmitted in L band, as used for the GPS signal. If a functional monitoring unit FKE, for example an appropriately programmed signal processor, detects the presence or absence of this pilot signal at the receiver EMP or at the antenna unit ANE, it is easily possible to identify an interruption in the signal transmission connection VER between the antenna unit ANE and the receiver EMP for the toll-payment unit EIN, in which case the monitoring signal SIG may be produced at time intervals which can be predetermined.

Another variant of an embodiment of the invention provides for the monitoring signal SIG to be generated by a vehicle-mounted signal generator GEN or by a monitoring point ENF on the road (FIG. 1), in which case a transmitter SEN may be provided to transmit the signal SIG to the antenna unit ANE. In response to this, the signal SIG may be transmitted via the signal transmission connection VER from the antenna unit ANE to the receiving unit EMP. At the end of the signal transmission connection VER which is associated with the receiving unit EMP, the functional monitoring unit FKE can detect the presence of the signal SIG and, if the signal SIG is absent, the functional monitoring unit FKE can generate an information signal. This information signal may be transmitted to an output unit, for example a light-emitting diode array, which displays a visual pattern (which is intended for this situation) on the vehicle FAR when an information signal is present.

A further variant of an embodiment of the invention as shown in FIG. 3 provides for the monitoring signal SIG to be fed from the functional monitoring unit FKE to the signal transmission connection VER, with the electrical characteristics of the signal transmission connection being determined. In this case, the expression electrical characteristics includes variables such as the impedance etc. In the embodiment mentioned above, the functional monitoring unit FKE may have its own signal generator. It is, of course, also possible for the signal generator to be physically separated from the functional monitoring unit FKE. In the following text, the expression functional monitoring unit FKE includes a unit including a process controller for carrying out the method according to an embodiment of the invention, and a signal generator. The functional monitoring unit FKE may also be in integrated form, as a chip.

If the load on the antenna end of the signal transmission connection VER can differ from the impedance of the signal transmission connection VER, this can lead to reflections of the monitoring signal SIG which is fed to it. The quality of this transmission system can be described by the ratio of the reflected component REF of the monitoring signal SIG to the monitoring signal SIG which is emitted from the functional monitoring unit FKE. This ratio is referred to as the voltage reflection coefficient r, and depends on the impedance of the transmission line as defined by the following equation:

$$r = \frac{SIG}{REF} = \frac{{Z}_{L} - {Z}_{0}}{{Z}_{L} - {Z}_{0}}$$

If, by way of example, the monitoring signal SIG is produced in the form of a continuous sine-wave voltage, and the impedance Z_{L} of the antenna unit ANE is not the same as the impedance Z₀ of the signal transmission connection VER, then the magnitude of the monitoring signal SIG will fluctuate cyclically between a maximum value and a minimum value. This fluctuation, the standing wave, is caused by the phase relationship between the wave that is fed in and the reflected wave. The ratio between the maximum and minimum values of this voltage is the voltage standing wave ratio σ, and depends on the reflection coefficient r as defined by the following equation:

$$σ = \frac{1 + \vert r \vert}{1 \vert r \vert}$$

Furthermore, the operating loss a, which is the logarithmic measure of the reflection coefficient r, is defined by the following formula:

α=−20 log(r)

If there is a discrepancy which can be predetermined between the determined standing wave ratio σ for the signal transmission connection VER or the reflection coefficient r, and/or the operating loss α of the signal transmission connection VER, from nominal values which can be predetermined, then the signal transmission connection VER between the antenna unit ANE and the receiving unit EMP may be classified as being faulty, and a malfunction of the antenna unit ANE may be diagnosed.

Time domain reflectometry has been found to be particularly suitable for functional monitoring of the antenna unit ANE. In this case, the functional monitoring unit FKE can feed the monitoring signal SIG to the signal transmission connection VER to be checked, for example in the form of a positive voltage rise. The monitoring signal SIG moves along the transmission line.

If the impedance of the antenna unit ANE corresponds the characteristic impedance of the transmission line, no signal will be reflected at the junction between the signal transmission line VER and the antenna unit ANE. However, if there is a mismatch at the antenna unit, part of the input voltage will be reflected. The reflected component REF of the monitoring signal SIG can easily be identified by the functional monitoring unit FKE, since it occurs at a different time to the monitoring signal SIG. This time difference can be used to determine the length D of the transmission path between the functional monitoring unit FKE and the discontinuity. This length D is calculated as follows:

$$D = {ν}_{ρ} \frac{T}{2} = \frac{{ν}_{ρ} T}{2}$$

where vₚ is the propagation velocity of the monitoring signal SIG, and T is the delay time from the functional monitoring unit FKE to the fault location and back. The propagation velocity vₚ can be determined experimentally using a cable of known length and of the same type. The fault location can be located unambiguously from knowledge of the propagation velocity vₚ as well as the measured time difference between the monitoring signal SIG being fed and detection of the reflected component REF.

The nature and the magnitude of the mismatch can be determined from the form of the reflected component REF, the reflected wave. As is known, knowledge of the monitoring signal SIG and of the reflected component REF, as measured by the functional monitoring unit FKE, allows the load impedance Z_{L} to be determined as function of the impedance Z₀ of the signal transmission connection VER, or vice versa—in this context, see, for example: “Dieter Dahlmeyer; Theorie der Zeitbereichsreflektometrie [Theory of time domain reflectometry], Parts 1, 2; elektronik industrie 2 [Electronics Industry 2] 2-2001; 3-2001”.

One positive feature of an embodiment of the invention is that any manipulation of the antenna unit ANE can be identified directly since, in consequence, the impedance of the antenna unit ANE may change, so that the reflected component REF of the monitoring signal SIG may also change. The change causing the fault can be identified by suitable choice of limit values or comparison with system-typical reference values. A further advantage of an embodiment of the invention is that any malfunction of the antenna unit ANE can be identified with little effort, in which case an information signal can be produced when an antenna malfunction is identified, and can be identified by a monitoring point external to the vehicle as the vehicle passes it.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for monitoring of an antenna unit of a vehicle-mounted toll-payment unit for an electronic toll system, wherein the toll-payment unit includes a receiving unit connected to the antenna unit, the method comprising:
producing at least one monitoring signal, which interacts with the antenna unit;
sending the at least one monitoring signal to the toll-payment unit; and
monitoring operation of the antenna unit based upon the at least one monitoring signal, wherein the at least one monitoring signal is produced as a pilot signal, is sent to the antenna unit, and a presence of the at least one monitoring signal is detectable at the receiving unit.

2. The method as claimed in claim 1, wherein the at least one monitoring signal is transmitted together with a position determination signal.

3. The method as claimed in claim 1, wherein the at least one monitoring signal is produced at predeterminable time intervals.

4. The method as claimed in claim 1, wherein the at least one monitoring signal is produced on board the vehicle.

5. The method as claimed in claim 1, wherein the at least one monitoring signal is produced by a vehicle-mounted functional monitoring unit connected to the toll-payment unit, and is sent to a signal transmission connection between the antenna unit and the receiving unit, with the functional monitoring unit determining at least one of electrical characteristics and reflection characteristics of the signal transmission connection from a reflected component of the monitoring signal.

6. The method as claimed in claim 5, wherein the monitoring signal (SIG) is used to determine values for at least one of the electrical characteristics and reflection characteristics of the signal transmission connection, and the values are compared with nominal values for these characteristics.

7. The method as claimed in claim 5, wherein an impedance of the signal transmission connection is determined.

8. The method as claimed in claim 5, wherein operating loss of the signal transmission connection between the antenna unit and the receiving unit is determined.

9. The method as claimed in claim 5, wherein at least one of the reflection characteristics and the electrical characteristics of the signal transmission connection between the antenna unit and the receiving unit are determined by way of time domain reflectometry.

10. The method as claimed in claim 1, wherein, when a malfunction is identified in the antenna unit, an appropriate information signal is produced and is displayed on the vehicle.

11. A toll system for electronic tolls, comprising:
a vehicle-mounted toll-payment unit including an antenna unit and a receiving unit, connected to the antenna unit, wherein the antenna unit is designed to receive position determination signals, and wherein the toll system is designed, for automatic functional monitoring of the antenna unit, to produce at least one monitoring signal for interacting with the antenna unit, to send the at least one monitoring signal to the toll-payment unit, and to use the at least one monitoring signal to monitor the operation of the antenna unit, and wherein the toll system is furthermore designed to produce the at least one monitoring signal as a pilot signal, to send the at least one monitoring signal to the antenna unit, and to detect presence of the at least one monitoring signal at the receiver.

12. The toll system as claimed in claim 11, wherein the toll system is designed to transmit the at least one monitoring signal together with a position determination signal.

13. The toll system as claimed in claim 11, wherein the toll system is designed to produce the at least one monitoring signal at predeterminable time intervals.

14. The toll system as claimed in claim 11, wherein a signal generator is provided on board the vehicle to produce the at least one monitoring signal.

15. The toll system as claimed in claim 11, wherein a functional monitoring unit, connected to the toll-payment unit, is provided on board the vehicle and is designed to produce the at least one monitoring signal and to send it to a signal transmission connection between the antenna unit and the receiving unit, wherein the functional monitoring unit furthermore is designed to determine at least one of electrical characteristics and reflection characteristics of the signal transmission connection from a reflected component of the at least one monitoring signal.

16. The toll system as claimed in claim 15, wherein the functional monitoring unit is designed to use the at least one monitoring signal to determine values for at least one of electrical characteristics and reflection characteristics of the signal transmission connection, and to compare these characteristics with nominal values for these characteristics.

17. The toll system as claimed in claim 15, wherein the functional monitoring unit is designed to determine impedance of the signal transmission connection.

18. The toll system as claimed in claim 15, wherein the functional monitoring unit is designed to determine the operating loss of the signal transmission connection between the antenna unit and the receiving unit.

19. The toll system as claimed in claim 15, wherein the functional monitoring unit is designed to determine at least one of the reflection characteristics of the signal transmission connection between the antenna unit and the receiving unit, and the electrical characteristics of the antenna unit, by way of time domain reflectometry.

20. The toll system as claimed in claim 11, wherein the toll system is designed, when a malfunction in the antenna unit is identified, to produce an appropriate information signal, and to display this on the vehicle.

21. The method as claimed in claim 2, wherein the at least one monitoring signal is produced at predeterminable time intervals.

22. The method as claimed in claim 2, wherein the at least one monitoring signal is produced on board the vehicle.

23. The method as claimed in claim 3, wherein the at least one monitoring signal is produced on board the vehicle.

24. The method as claimed in claim 6, wherein an impedance of the signal transmission connection is determined.

25. The method as claimed in claim 6, wherein operating loss of the signal transmission connection between the antenna unit and the receiving unit is determined.

26. A toll system for electronic tolls, comprising:
a vehicle-mounted toll-payment unit including an antenna unit and a receiving unit, connected to the antenna unit, wherein the antenna unit is designed to receive position determination signals;
means, for automatic functional monitoring of the antenna unit, for producing at least one monitoring signal for interacting with the antenna unit, for sending the at least one monitoring signal to the toll-payment unit, and for using the at least one monitoring signal to monitor the operation of the antenna unit; and
means for producing the at least one monitoring signal as a pilot signal, and for sending the at least one monitoring signal to the antenna unit, wherein presence of the at least one monitoring signal is detectable at the receiver.

27. A method for monitoring of a vehicle-mounted toll-payment unit for an electronic toll system, the method comprising:
producing at least one monitoring signal as a pilot signal;
sending the at least one monitoring signal to an antenna unit of the toll-payment unit; and
monitoring operation of the antenna unit based upon the at least one monitoring signal, wherein presence of the at least one monitoring signal is detectable.

28. The method of claim 27, wherein the vehicle-mounted toll-payment unit includes an antenna unit and a receiving unit, and wherein presence of the at least one monitoring signal is detectable at the receiving unit.

29. A device for monitoring of a vehicle-mounted toll-payment unit for an electronic toll system, the device comprising:
means for producing at least one monitoring signal as a pilot signal;
means for sending the at least one monitoring signal to an antenna unit of the toll-payment unit; and
means for monitoring operation of the antenna unit based upon the at least one monitoring signal, wherein presence of the at least one monitoring signal is detectable.

30. The device of claim 29, wherein the vehicle-mounted toll-payment unit includes an antenna unit and a receiving unit, and wherein presence of the at least one monitoring signal is detectable at the receiving unit.

31. A vehicle-mounted toll-payment unit for an electronic toll system, comprising:
an antenna unit; and
a receiving unit, connected to the antenna unit, wherein the antenna unit is designed to receive at least one monitoring signal from the toll-payment unit, wherein the at least one monitoring signal is used to monitor the operation of the antenna unit, and wherein the at least one monitoring signal includes a pilot signal, and wherein presence of the at least one monitoring signal is detectable at the receiver.

32. A method for monitoring of a vehicle-mounted toll-payment unit for an electronic toll system, the method comprising:
receiving, at an antenna unit of the toll-payment unit, at least one monitoring signal, produced as a pilot signal by the toll system, wherein operation of the antenna unit is monitored based upon the at least one monitoring signal, and wherein presence of the at least one monitoring signal is detectable.

33. The toll system as claimed in claim 12, wherein the toll system is designed to produce the monitoring signal at predeterminable time intervals.

34. The toll system as claimed in claim 12, wherein a signal generator is provided on board the vehicle to produce the at least one monitoring signal.

35. The toll system as claimed in claim 16, wherein the functional monitoring unit is designed to determine impedance of the signal transmission connection.
